(19) United States
(12) Patent Application Publication
(10) Pub. No.: US 2011/0019425 A1
(43) Pub. Date: Jan. 27, 2011

(54) LED LAMP

(75) Inventors: CHIN-CHUNG CHEN, Tu-Cheng (TW); HAI-WEI ZHANG, Shenzhen (CN)

Correspondence Address: Altis Law Group, Inc.;ATTN: Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/607,974

(22) Filed: Oct. 28, 2009

(30) Foreign Application Priority Data
Jul. 27, 2009 (CN) 200910304860.3

(51) Int. Cl. F21V 5/00

(52) U.S. Cl. 362/311.02

(57) ABSTRACT

An LED lamp includes an LED having an optical axis and an elongated lens covering the LED. The lens has an incident face for incidence of the light of the LED and an opposite emitting face for retracting the light of the LED out of the lens. The optical axis of the LED extends through the incident face. A first plane on which the optical axis of the LED is located intersects the emitting face. In the first plane, an intensity I_{α} of the light emitting from the emitting face at a position offset from the optical axis of the LED with an angle α satisfies equation: ∫_{-π/2}⁰I_{α}dα>∫₀^{π/2}I_{α}dα.

### BACKGROUND

1. Technical Field

The present disclosure relates generally to LED lamps, and more particularly to an LED lamp with an improved lens.

2. Description of Related Art

LED lamp, a solid-state lighting, utilizes LEDs as a source of illumination, providing advantages such as resistance to shock and nearly limitless lifetime under specific conditions. Thus, LED lamps present a cost-effective yet high quality replacement for incandescent and fluorescent lamps.

Known implementations of LED lamps in an LED lamp employ lenses for focusing light generated by the LEDs. However, a light pattern provided by such an LED lamp is substantially round, and is not suitable for illuminating a certain location, such as roadway, which has a need to be able to direct light to a middle of the roadway instead of lighting on a region neighboring a roadside of the roadway, such as houses beside the roadway. Apparently, the round light pattern provided by the conventional LED lamp can not satisfy such a requirement.

What is need therefore is an LED lamp which can overcome the above limitations.

### BRIEF DESCRIPTION OF THE DRAWINGS

FIG. 1 is an isometric, assembled view of an LED lamp in accordance with an exemplary embodiment.

FIG. 2 is an inverted view of a lens of the LED lamp of FIG. 1.

FIG. 3 is a top plan view of the lens of the LED lamp of FIG. 1.

FIG. 4 is a cross-sectional view of the LED lamp of FIG. 1, taken along line III-III thereof.

FIG. 5 is a cross-sectional view of the LED lamp of FIG. 1, taken along line IV-IV thereof.

FIG. 6 is a graph of light intensities of the LED lamp of FIG. 1.

FIG. 7 is a view similar to FIG. 5, showing a light path of the LED lamp of FIG. 1.

FIG. 8 shows a vector resolution of a light of the LED lamp emitting out of the lens in planes XOZ and YOZ.

FIG. 9 is a view similar to FIG. 4, showing a component of the light of FIG. 8 in the plane XOZ deviating from an optical axis of an LED of the LED lamp with an angle φ.

FIG. 10 is a view similar to FIG. 5, showing a component of the light of FIG. 8 in the plane YOZ deviating from the optical axis of the LED of the LED lamp with an angle θ.

### DETAILED DESCRIPTION

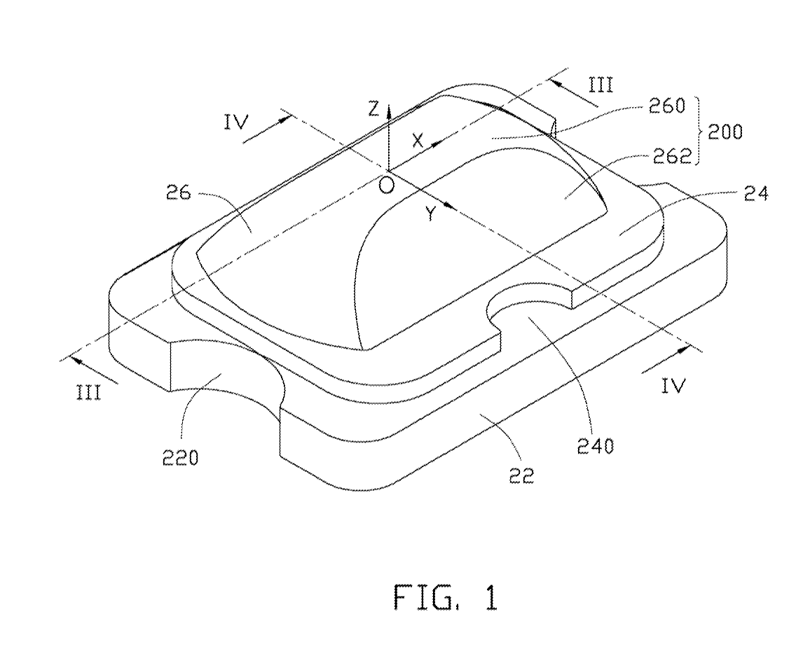

FIGS. 1 to 4 illustrate an LED lamp in accordance with an exemplary embodiment. The LED lamp includes an LED 10 and a lens 20 covering the LED 10.

Referring to FIG. 1, a three dimensional coordinate system, with origin O and axes X, Y and Z, oriented as shown by the arrows in FIG. 1, is adopted to clearly describe the LED lamp. The X-axis extends along a front-to-rear direction, the Y-axis extends along a left-to-right direction, and the Z-axis extends along a bottom-to-top direction. Any two of the three axes X, Y, Z are perpendicular to each other. The X-axis and the Z-axis cooperatively define a first plane XOZ, the Y-axis and the Z-axis cooperatively define a second plane YOZ, and the X-axis and the Y-axis cooperatively define a third plane XOY. The first plane XOZ and the second plane YOZ are vertical, and are perpendicularly intersected at the Z-axis. The third plane XOY is horizontal, perpendicularly intersected to the first plane XOZ at the X-axis and perpendicularly intersected to the second plane YOZ at the Y-axis.

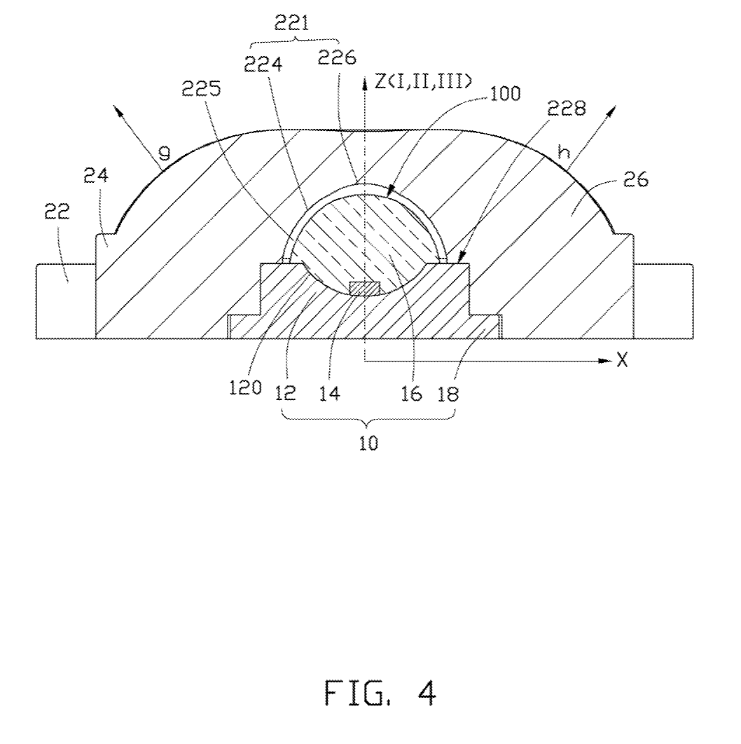

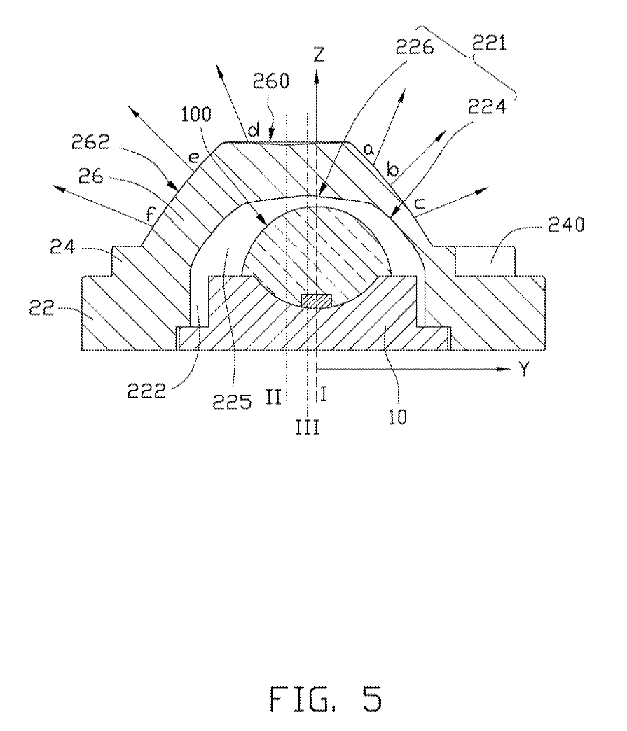

Referring to FIGS. 4 and 5, the LED 10 includes a rectangular substrate 12, an LED chip 14 and an encapsulant 16. A flange 18 extends outwardly from each lateral side of the substrate 12 for mounting the substrate 12 to the lens 20. A recess (not labeled) is defined in a top of the substrate 12. The LED chip 14 is received in and located at a center of the recess. The substrate 12 forms a bowl-shaped reflecting surface 120 at a bottom of the recess for reflecting light generated by the LED chip 14 to the encapsulant 16. The encapsulant 16 fills the recess and thus fixes the LED chip 14 on the substrate 12. A profile of the encapsulant 16 is substantially dome-shaped for being acted as a primary convex lens to collimate light emitted from the LED chip 14. An outer surface of the encapsulant 16 functions as an emitting surface 100 of the LED 10. Preferably, in this embodiment, the emitting surface 100 is spherical, and has an optical axis I coincidental with the Z-axis. In other words, the optical axis I vertically extends through the origin O of the X-Y-Z coordinate. The LED chip 14 is located on the optical axis I of the LED 10.

Referring to FIG. 1 again, the lens 20 is integrally made of a light-transparent material, such as PC (polycarbonate) or PMMA (poly (methyl methacrylate)). The lens 20 is elongated in profile with long sides extending along the X-axis and short sides extending along the Y-axis. The lens 20 is symmetric relative to the second plane YOZ, while is asymmetric relative to the first plane XOZ.

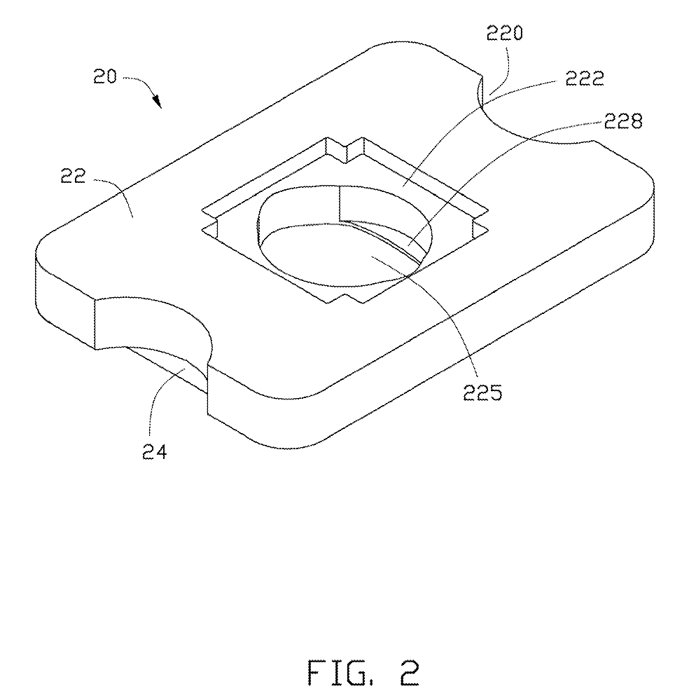

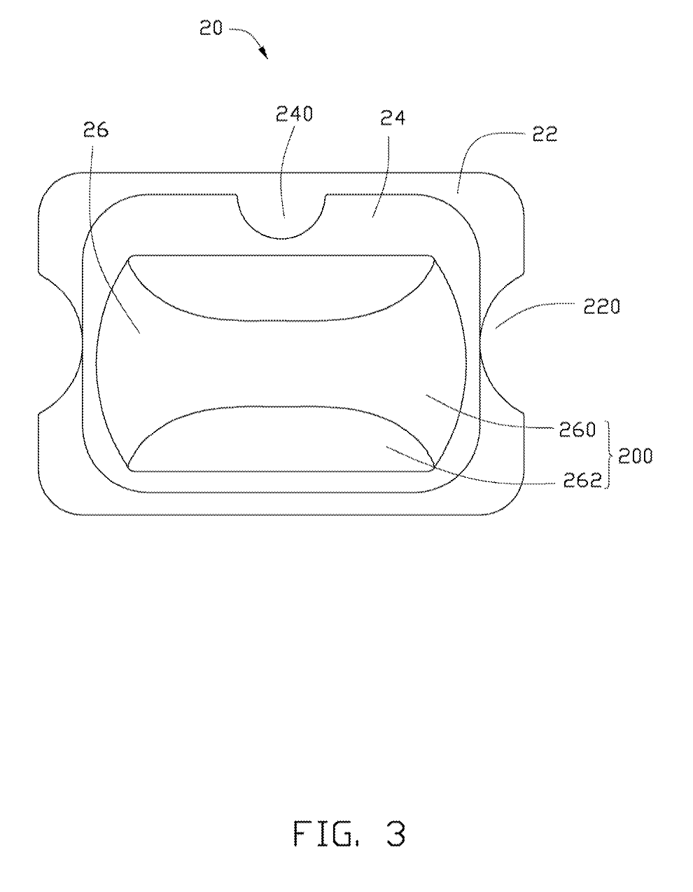

Referring to FIGS. 2 and 3 simultaneously, the lens 20 includes a supporting base 22, a connecting member 24 and a guiding member 26. The supporting base 22 is substantially rectangular, and has two arc cutouts 220 respectively defined at two opposite short sides thereof.

The connecting member 24 is formed on a top side of the supporting base 22. The connecting member 24 is substantially rectangular, and has a length and a width both being smaller than those of the supporting base 22. Each short side of the connecting member 24 is tangential to a corresponding cutout 220 of the supporting base 22. A semicircular void 240 is defined in a right long side of the connecting member 24.

The guiding member 26 extends upwardly from a top side of the connecting member 24. The guiding member 26 is located closer to a left long side of the connecting member 24 without the void 240, thereby adjusting light emitted from the LED 10 to the left side of the LED lamp. An outer surface of the guiding member 26 functions as an emitting face 200 of the LED lamp for the light of the LED 10. The emitting face 200 refracts the light out of the lens 20. The emitting face 200 in whole has a profile being generally convex.

The emitting face 200 includes two elongated, ellipsoid minor surfaces 262 extending upwardly and inwardly from two longer sides of the guiding member 26, and a major surface 260 located between and connecting with the two ellipsoid minor surfaces 262. An optical axis II of the emitting face 200 of the LED lamp extends through a center of the major surface 260. The optical axis II of the emitting face 200 of the LED lamp is parallel to and offset from the optical axis I of the emitting surface 100 of the LED 10. The optical axis II of the emitting face 200 and the optical axis I of the emitting surface 100 both are located on the second plane YOZ with the optical axis II of the emitting face 200 at a left side of the optical axis I of the emitting surface 100. That is, the emitting face 200 is symmetrical relative to the second plane YOZ, and is symmetrical relative to a plane which is parallel to the first plane XOZ and has the optical axis II of the emitting face 200 located thereon.

The major surface 260 is a compound irregular surface consisted of some different surfaces. In this embodiment, the major surface 260 has a substantially flat plane located at a middle, top thereof and two spheroid surfaces located at two ends of the flat plane. The two ellipsoid minor surfaces 262 of the emitting face 200 are the same as each other, and are arranged symmetrically at two sides of the major surface 260. Each ellipsoid minor surface 262 is inclined inwardly along the bottom-to-top direction. A width of each ellipsoid minor surface 262 increases gradually from two ends to a middle of the lens 20, while a width of the major surface 260 decreases gradually from two ends to the middle. Bottom sides of the ellipsoid minor surfaces 262 and two bottom edges of the major surface 260 connect the top side of the connecting member 24. A joint of each ellipsoid minor surface 262 and the top side of the connecting member 24 is straight, while a joint of each bottom edge of the major surface 260 and the top side of the connecting member 24 is convex outwardly.

Referring to FIGS. 2, 4 and 5, the lens 20 defines a cavity 222 at a central portion of the supporting base 22 for receiving the substrate 12 of the LED 10 therein. Further, a dent 225 is concaved upwardly from a central portion of a bottom of the connecting member 24 into the guiding member 26. The dent 225 is defined above and communicated with the cavity 222. A step 228 is formed by the lens 20 at a location between the cavity 222 and the dent 225. When the substrate 12 of the LED 10 is received in the cavity 222, an outer portion of the top face of the substrate 12 around the encapsulant 16 abuts against the step 228 to limit movement of the LED 10 along the Z-axis.

The dent 225 is used for receiving a top portion of the encapsulant 16 protruding upwardly from the substrate 12. A portion of the guiding member 26 around the dent 225 functions as an incident face 221 of the lens 20 for incidence of the light of the LED 10 into the lens 20. In this embodiment, a size of the dent 225 is slightly larger than that of the top portion of the encapsulant 16, and thus the encapsulant 16 of the LED 10 is spaced from the incident face 221 of the lens 20 when the LED 10 is assembled into the lens 20 to form the present LED lamp.

The incident face 221 in whole has a profile being generally concave upwardly. The incident face 221 includes a curved surface 224 and a spherical surface 226 concaved upwardly from a central portion of the curved surface 224 into the guiding member 26 of the lens 20. An optical axis III of the incident face 221 extends through a center of the spherical surface 226 of the incident face 221. The optical axis III of the incident face 221 of the lens 20 is located on the second plane YOZ, and is parallel to the optical axis II of the emitting face 200 and the optical axis I of emitting surface 100 of the LED 10. Thus the three optical axes I, II, III of the emitting surface 100, the emitting face 200 and the incident face 221 are parallel to each other. The optical axis III of the incident face 221 is located between the optical axis I of the emitting surface 100 and the optical axis II of the emitting face 200, and is closer to the optical axis I of the emitting surface 100 than to the optical axis II of the emitting face 200. Since the optical axis III of the incident face 221 is located at the right side of the optical axis II of the emitting face 200, a cross section of the lens 20 taken along the second plane YOZ is symmetrical relative to none of the optical axes I, II, III of the LED 10. A thickness of the lens 20 at the left side of the first plane XOZ is larger than that at the right side.

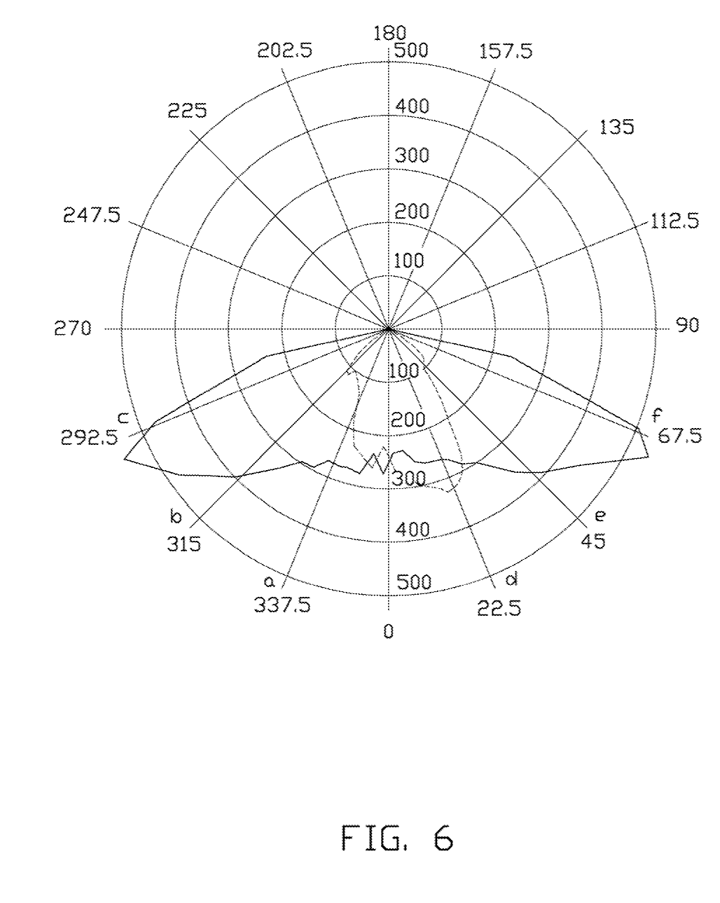

FIG. 6 shows a dotted line and a solid line respectively indicating the intensities of the light of the present LED lamp, i.e., the light emitted from the emitting face 20, in the first plane XOZ and the second plane YOZ vs. the radiating angles of the LED lamp. Since the lens 20 is symmetric to the second plane YOZ, the intensities at opposite sides of the second plane YOZ are substantially identical to each other, as indicated by the solid line of FIG. 6.

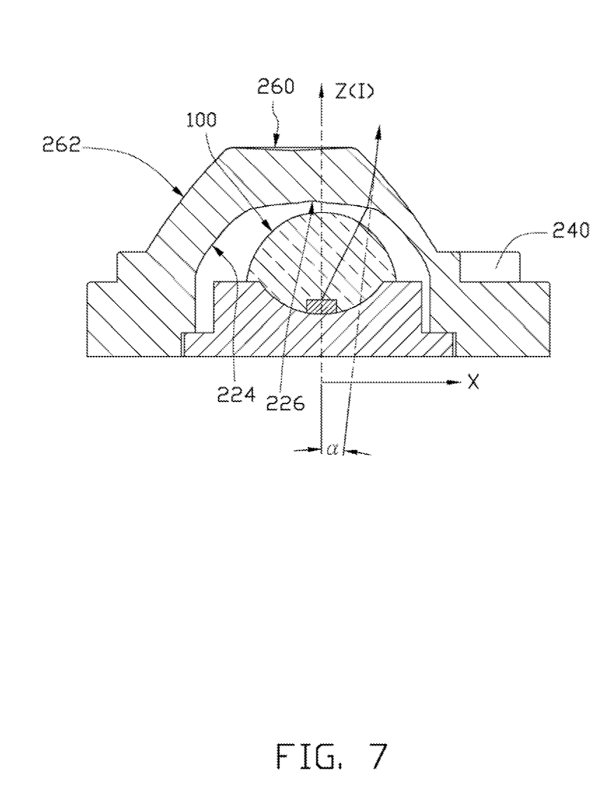

Further, for the optical axis III of the incident face 221 of the lens 20 and the optical axis II of the emitting face 200 of the LED lamp offset leftwards from the optical axis I of the LED 10, most of the light emitted from the LED 10 is refracted out of the lens 20 and biases leftwards, as shown in FIG. 7. Thus intensities of the light of the LED lamp at opposite sides of the first plane XOZ are quite different from each other.

Referring to FIG. 5, taking the second plane YOZ for example, as indicated by the dotted line of FIG. 6, the intensities of the light of the LED lamp in the left side of the optical axis I of the LED 10 is much larger than that at the right side of the optical axis I. In the left side, with an increase of the angle between the light and the optical axis I of the LED 10, the intensity of the light of the LED lamp firstly increases to position d and then decreases to positions e and f in sequence. The peak intensity in the left side occurs at position d, and the zero intensity occurs at position f. The intensity at position e is about ⅓ of the peak intensity at position d. The angle between position a and the optical axis I of the LED 10 is about 22.5 degrees, the angle between position e and the optical axis I of the LED 10 is about 45 degrees, and the angle between position f and the optical axis I of the LED 10 is about 67.5 degrees.

In the right side of the of the optical axis I of the LED 10, with an increase of the angle between the light and the optical axis I, the intensities of the light of the LED lamp keeps decreasing continuously. At position a, which offsets rightwards from the optical axis I of the LED 10 about 22.5 degrees, the light intensity is about a half of the light intensity at position d. The intensity at position b, which offsets rightwards from the optical axis I about 45 degrees, substantially equals to the light intensity at position e. At position c, which offsets rightwards from the optical axis I about 67.5 degrees, the light intensity is nearly zero.

The intensity of the light of the LED lamp at a position offset from the optical axis I of the LED 10 with an angle α is denoted as I_{α}. Assuming that the angle between the optical axis I of the LED 10 and the light at the right side is positive, the angle between the optical axis I and the light at the left side is negative. From the above, the intensity I_{α} of the light of the LED lamp at the left side of the optical axis I within the angle α>−45 degrees is larger than that at the right side the optical axis I within the angle α<45. That is, the intensity I_{α} of the light emitting from the emitting face 200 is an area with the angle −45<α<45 should satisfy equation:

∫₀^{π/4}I_{α}dα<∫_{-π/4}⁰I_{α}dα (1)

While the intensity I_{α} of the light of the LED lamp at the left side of the optical axis I within the angle α<−45 degrees is approximately the same as than that at the right side the optical axis I within the angle α>45. That is, the intensity I_{α} of the light of the LED lamp in an area with the angle 45<α and α<−45 should satisfy equation:

∫_{π/4}^{π/2}I_{α}dα=∫_{-π/2}^{-π/4}I_{α}dα (2)

According to above equations (1) and (2), the intensity I_{α} of the light of the LED lamp around the optical axis I of the emitting surface 100 of the LED 10 should satisfy equation:

∫_{-π/2}⁰I_{α}dα>∫₀^{π/2}I_{α}dα (3)

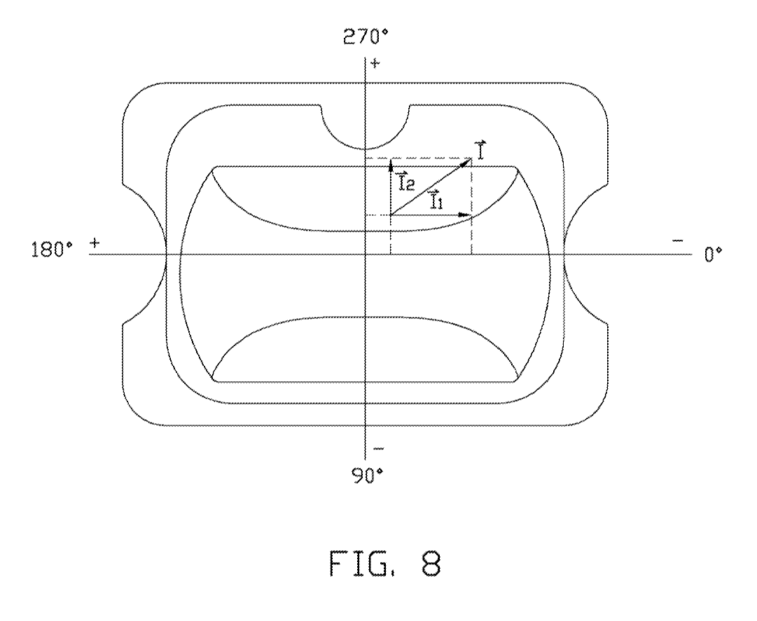

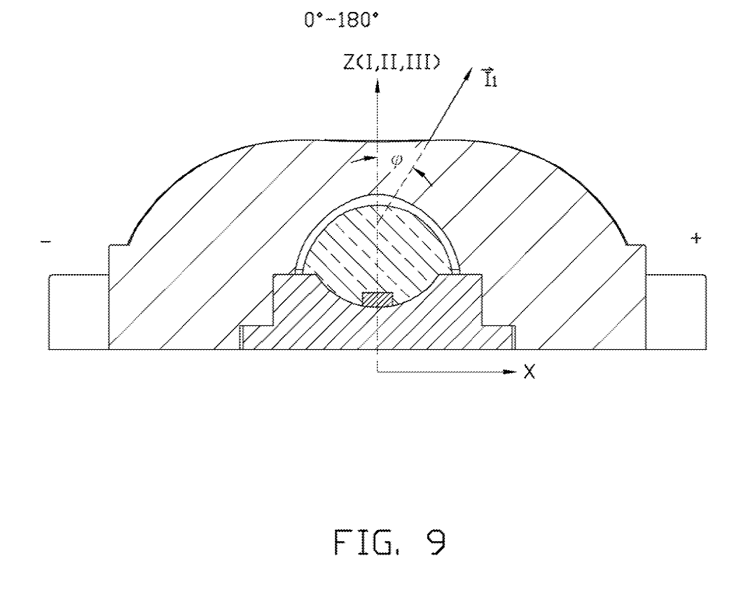

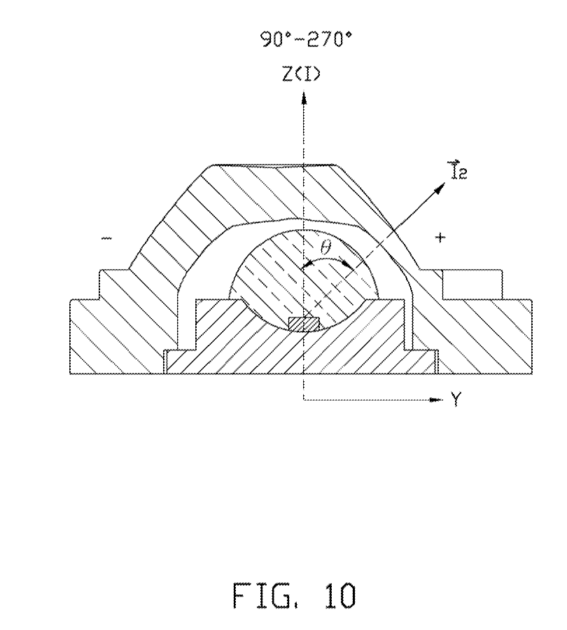

Referring to FIG. 8, \vec{I} is used for indicating a vector of the light of the LED lamp. A component of the light \vec{I} in the first plane XOZ is denoted as \vec{I}₁, and a component of the light \vec{I} in the second plane YOZ is denoted as \vec{I}₂. Referring to FIG. 9, an angle defined between the optical axis I of the LED 10 and the component \vec{I}₁ in the first plane XOZ is denoted as φ. FIG. 10 shows an angle defined between the optical axis I of the LED 10 and the component \vec{I}₂ of the light \vec{I} in the second plane YOZ being denoted as θ. The intensity of the light \vec{I} is denoted as I(φ, θ). Since the intensity of the light in the left side of the optical axis I of the LED 10 is much larger than that at the right side optical axis I, Φ₁ should be larger than Φ₂, in which:

$${Φ}_{1} = {\int }_{- π / 2}^{π / 2} {\int }_{- π / 2}^{0} I ( ϕ , θ ) 4 ( arc tg \frac{tg θ}{tg ϕ} - arc sin ( cos ϕsin ( arc tg \frac{tg θ}{tg ϕ} ) ) + arc tg \frac{tg ϕ}{tg θ} - arc sin ( cos θsin ( arc tg \frac{tg ϕ}{tg θ} ) ) ) d ϕ d θ ; and$$

$${Φ}_{2} = {\int }_{- π / 2}^{π / 2} {\int }_{0}^{π / 2} I ( ϕ , θ ) 4 ( arc tg \frac{tg θ}{tg ϕ} - arc sin ( cos ϕsin ( arc tg \frac{tg θ}{tg ϕ} ) ) + arc tg \frac{tg ϕ}{tg θ} - arc sin ( cos θsin ( arc tg \frac{tg ϕ}{tg θ} ) ) ) d ϕ d θ .$$

In the above equations, the angle φ between the optical axis I of the LED 10 and the component \vec{I}₁ of the light \vec{I} in the first plane XOZ at the rear side of the optical axis I is positive, while the angle φ between the optical axis I and the component \vec{I}₁ at the front side of the optical axis I is negative. The angle θ between the optical axis I of the LED 10 and the component \vec{I}₂ of the light \vec{I} in the second plane YOZ at the right side of the optical axis I is positive, while the angle θ between the optical axis I and the component \vec{I}₂ at the left side of the optical axis I is negative.

When the present LED lamp is utilized as a street lamp on a side of a road, the lens 20 of the LED lamp is arranged in such a manner that the X-axis is parallel to a longitudinal direction of the road while the Y-axis is parallel to a transverse direction of the road. The right side of the lens 20 with the void 240 is arranged facing a region neighboring a roadside the road, while the left side of the lens 20 without the void 240 faces a middle of the road. The light emitted from the LED 10 is refracted by the lens 20 to form a substantially elongated illumination region on the road. An illumination area along the longitudinal direction of the road is larger than that along the transverse direction of the road. An illumination area along the transverse direction of the road biases from the roadside of the road towards the middle of the road to thereby provide a sufficient illumination for the middle of the road. In other words, in the transverse direction, more light are directed to the middle of the road than the roadside.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An LED lamp comprising:
an LED having an optical axis; and
a lens covering the LED, the lens having an incident face for incidence of light of the LED into the lens and an opposite emitting face for refracting the light of the LED out of the lens, the optical axis of the LED extending through the incident face, a first plane on which the optical axis of the LED is located intersecting the emitting face, wherein in the first plane, an intensity I_{α} of the light emitting from the emitting face at a position offset from the optical axis of the LED with an angle α satisfies equation: ∫_{-π/2}⁰I_{α}dα>∫₀^{π/2}I_{α}dα.

2. The LED lamp of claim 1, wherein in the first plane, the intensity I_{α} of the light further satisfies equations: ∫₀^{π/4}I_{α}dα<∫_{-π/4}⁰I_{α}dα and ∫_{π/4}^{π/2}I_{α}dα=∫_{-π/2}^{-π/4}I_{α}dα.

3. The LED lamp of claim 1, wherein the incident face is concave, while the emitting face is convex, the LED being entirely received in the lens and spaced from the incident face.

4. The LED lamp of claim 1, wherein the emitting face comprises two ellipsoid minor surfaces and a major surface located between and connecting the two ellipsoid minor surfaces.

5. The LED lamp of claim 4, wherein a width of the major surface of the emitting face decreases from two ends to a middle of the lens, and widths of the ellipsoid minor surfaces increase from two the ends to the middle of the lens.

6. The LED lamp of claim 1, wherein the incident face comprises a curved surface and a spherical surface concaved from a central portion of the curved surface towards the emitting face.

7. The LED lamp of claim 1, wherein an optical axis of the emitting face offsets from an optical axis of the incident face.

8. The LED lamp of claim 7, wherein the optical axis of the incident face offsets from the optical axis of the LED.

9. The LED lamp of claim 8, wherein the optical axes of the incident face, the emitting face, and the LED are coplanar and located at the first plane, the optical axis of the incident face being located between the axes of the emitting face and the LED, and closer to the optical axis of the LED than to the optical axis of the emitting face.

10. The LED lamp of claim 9, wherein the optical axes of the incident face and the emitting face are both parallel to the axis of the LED.

11. The LED lamp of claim 10, wherein a thickness of the lens at opposite sides of the first plane are different from each other.

12. The LED lamp of claim 1, wherein a cross section of the lens taken along the first plane is symmetric to none of the optical axes of the incident face, the emitting face, and the LED.

13. The LED lamp of claim 1, wherein the lens is symmetric to the first plane, and is asymmetric to a second plane which is perpendicularly intersected with the first plane at the optical axis of the LED.

14. An LED lamp, comprising:
an LED comprising an LED chip and an encapsulant encapsulating the LED chip, the encapsulant having an emitting surface for light of the LED chip emitting out the LED, the emitting surface having a first optical axis; and
a lens covering the LED, the LED comprising an incident face facing the emitting face of the LED and an opposite emitting face, the first optical axis of the emitting surface of the LED extending through the incident face and the emitting face of the lens, a component of a light of the LED lamp emitting from the emitting face in a first plane deviating an angle φ from the first optical axis, and a component of the light of the LED lamp emitting out of the emitting face in a second plane which is perpendicularly intersected with the first plane at the optical axis deviating an angle θ from the first axis, an intensity of the light I(φ, θ) satisfying equations: Φ1>Φ2, in which:
$${Φ}_{1} = {\int }_{- π / 2}^{π / 2} {\int }_{- π / 2}^{0} I ( ϕ , θ ) 4 ( arc tg \frac{tg θ}{tg ϕ} - arc sin ( cos ϕsin ( arc tg \frac{tg θ}{tg ϕ} ) ) + arc tg \frac{tg ϕ}{tg θ} - arc sin ( cos θsin ( arc tg \frac{tg ϕ}{tg θ} ) ) ) d ϕ d θ ; and$$
$${Φ}_{2} = {\int }_{- π / 2}^{π / 2} {\int }_{0}^{π / 2} I ( ϕ , θ ) 4 ( arc tg \frac{tg θ}{tg ϕ} - arc sin ( cos ϕsin ( arc tg \frac{tg θ}{tg ϕ} ) ) + arc tg \frac{tg ϕ}{tg θ} - arc sin ( cos θsin ( arc tg \frac{tg ϕ}{tg θ} ) ) ) d ϕ d θ .$$

15. The LED lamp of claim 14, wherein the first optical axis of the emitting surface, a second optical axis of the emitting face, and a third optical axis of the incident face are coplanar, the third optical axis being located between the first optical axis and the second optical axis, and closer to the first optical axis than to the second optical axis.

16. The LED lamp of claim 15, wherein the emitting face comprises two ellipsoid minor surfaces and a major surface located between and connecting the two ellipsoid minor surfaces, the second optical axis extending through the major surface, a width of the major surface decreasing from two ends to a middle of the lens, and widths of the ellipsoid minor surfaces increasing from the two ends to the middle of the lens.

17. The LED lamp of claim 15, wherein the incident face comprises a concaved curved surface and a spherical surface concaved from a central portion of the curved surface towards the emitting face, the third optical axis extending through the spherical surface of the incident face.

18. The LED lamp of claim 15, wherein the lens is symmetric to the second plane, and is asymmetric to the first plane, a cross section of the lens taken along the second plane being symmetric to none of the first, second and third optical axes of the incident face, the emitting face and the LED.

19. The LED lamp of claim 14, wherein the emitting surface of the LED is separated from the incident face of the lens.

20. The LED lamp of claim 14, wherein the LED is entirely received in the lens.
